(19) United States
(12) Patent Application Publication
(10) Pub. No.: US 2007/0077815 A1
(43) Pub. Date: Apr. 5, 2007

(54) Modular messaging center, organizer, and personal convenience system

(76) Inventors: John White, Chicago, IL (US); Sean Schubert, Chicago, IL (US); Matthew J. Gerules, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/242,717

(22) Filed: Oct. 3, 2005

(51) Int. Cl. H01R 13/648

(52) U.S. Cl. 439/607

(57) ABSTRACT

A system of various messaging, personal convenience, and organizational products, each taking the form of a component or module, and all of which are securable to one another in such a manner that a user is provided with a wide array of possible customizable configuration options. The components are interconnected by fasteners, such as clips, secured to adjacent walls that project rearwardly from a front surface of each of the components.

### FIELD OF THE DISCLOSURE

This disclosure relates generally to messaging boards, organizational products, and personal convenience items and, more specifically, to a modular system for combining, in a customized manner, various messaging accessories such as note pads, dry-erase boards, corkboards, and chalkboards, as well as other personal convenience products and organizational products, such as a clock, a picture holder, a mirror, and a writing utensil receptacle.

### BACKGROUND

Individual tastes, habits, and preferences vary widely with regard to messaging, planning, organization, and other routine activities typically conducted in or near a kitchen, home office, dorm room, school locker, or work cubicle environment. Space in such areas for the provision of messaging products, personal convenience products, and organizational products are usually limited. Given these factors, it would be desirable if individuals could optimize the limited space by displaying, in a readily accessible location, a modular, customizable, multi-task system including only those messaging, personal convenience, and organizational products that suit their particular needs and style.

It would further be desirable if such a system were adapted to allow individuals to easily add on more messaging, personal convenience, and/or organizational products, or replace such products within their customized system as their personal needs, tastes, or desires change, or as products require. For instance, certain product components within an individual's system of messaging, personal convenience, and organizational products may require refills, which might most easily be accomplished by replacement of those particular components of the individual's system. It would further be desirable if all the product components available for individuals to select and combine for their customized system could be aesthetically and structurally compatible.

### SUMMARY

A system of various messaging, personal convenience, and organizational products, each taking the form of a component or module, and all of which are securable to one another in such a manner that a user is provided with a wide array of possible customizable configuration options, is disclosed. The components or modules, however many, are combined and secured together by the user in any desired arrangement, and may be mounted to a wall or other vertical surface, such as the rear panel of a locker door. The messaging, personal convenience, and organizational products, each of which defines an optional component for use in the system of this disclosure, may include (but are not limited to) a dry-erase board, a wet-erase board, a pin-board (such as corkboard, a fabric, or fabric-covered foam), a chalkboard, a mirror, a clock (either analog or digital), a holder for a supply of gently adhesively interconnected notes, a holder for a cellular telephone, a hook area for keys, a voice message recorder, a writing utensil receptacle or holder, and a picture display panel. The picture display panel may be one in which a picture or other document may be inserted behind a transparent protective wall, or alternately, the picture or other document may be secured to the display panel by pockets disposed at the corners of the display panel, with each such pocket adapted to receive a corresponding corner of the picture or other document to be secured thereto.

Each component is provided with a front surface and one or more rearwardly-projecting walls of similar depth. The rearwardly-projecting walls of adjacent components are connected to one another. In an exemplary embodiment, the rearwardly-projecting walls of adjacent components are connected via clips each having first and second legs. At least one of the first and second legs of each of the clips is biased toward the other of the first and second legs. Each rearwardly-projecting wall may have a reduced wall thickness over a clip-receiving span thereof. This reduced wall thickness facilitates placement of one of the clips along the clip-receiving span of the rearwardly-projecting walls of two components so as to secure the two components to one another.

In a similar fashion, a rearwardly-projecting wall of a third component may be brought into register with any of the unoccupied rearwardly-projecting walls of the first two components. A second clip may then be applied to the clip-receiving spans of the rearwardly-projecting wall of the third component and of the previously unoccupied rearwardly-projecting wall, thereby interconnecting three components. Each of the three interconnected components is preferably a different messaging, personal convenience, or organizational product. This process may be continued until all desired components are interconnected, in desired relative locations.

At least some of the clips used to connect adjacent messaging, personal convenience, and organizational product components may be adapted to receive at least one retention bracket or hook to facilitate mounting one of the components or a plurality of interconnected components to a wall or other vertical surface.

### BRIEF DESCRIPTION OF THE SEVERAL VIEWS OF THE DRAWING

FIG. 1 is a perspective view of a system of interconnected messaging, personal convenience, and organizational product components of the present disclosure;

FIG. 2 is a rear perspective view of the system of interconnected messaging, personal convenience, and organizational product components of the present disclosure;

FIG. 3 is a rear perspective view, partially broken away, of two adjacent messaging, personal convenience, or organizational product components interconnected by a first shown), and a picture display panel 22. A writing utensil receptacle or holder 24 may be provided as an integral part of one of the other components, such as the dry-erase board 10, or alternately, may be provided as another independent connectable component.

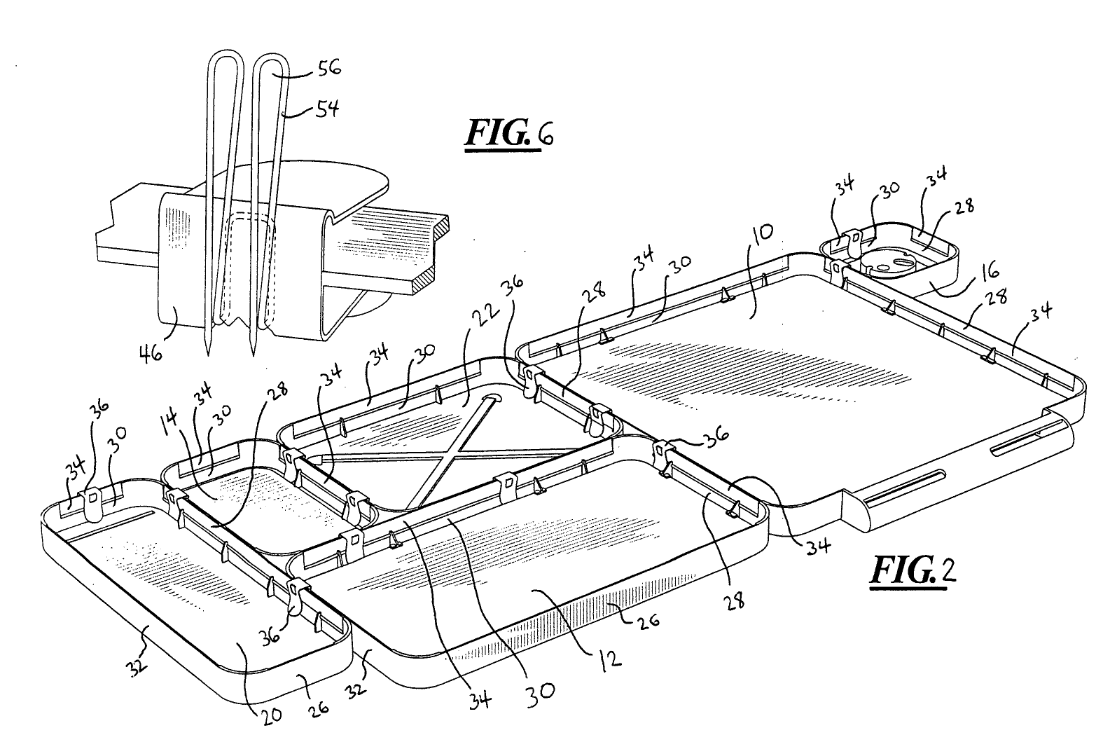

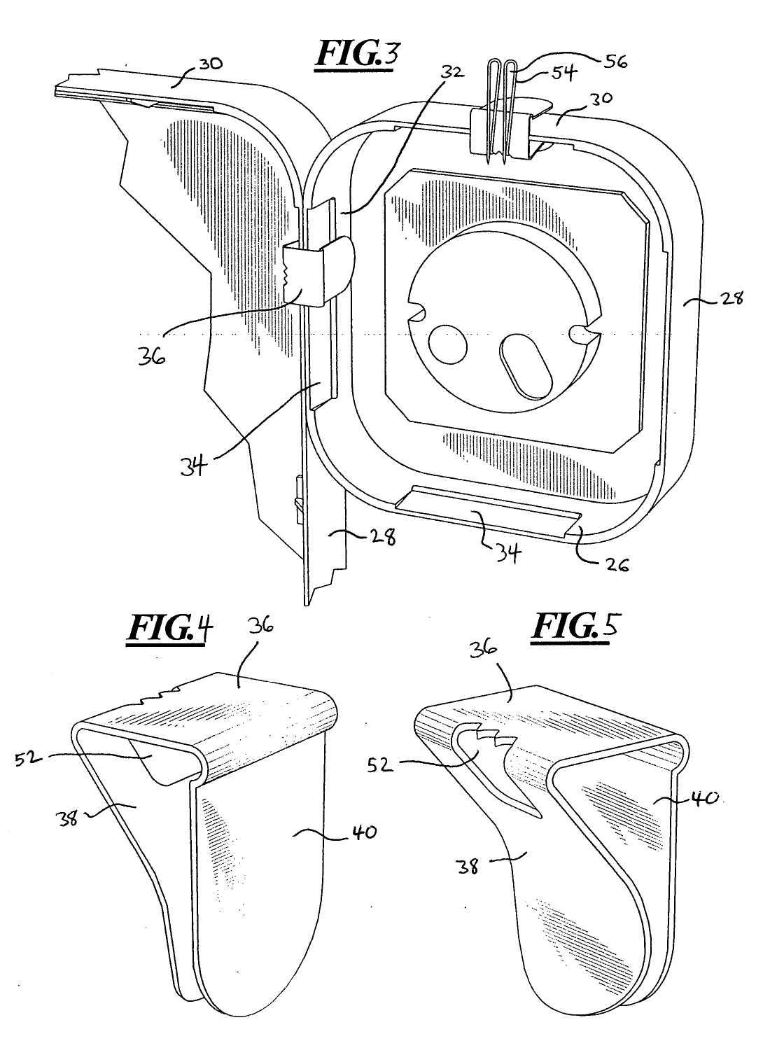

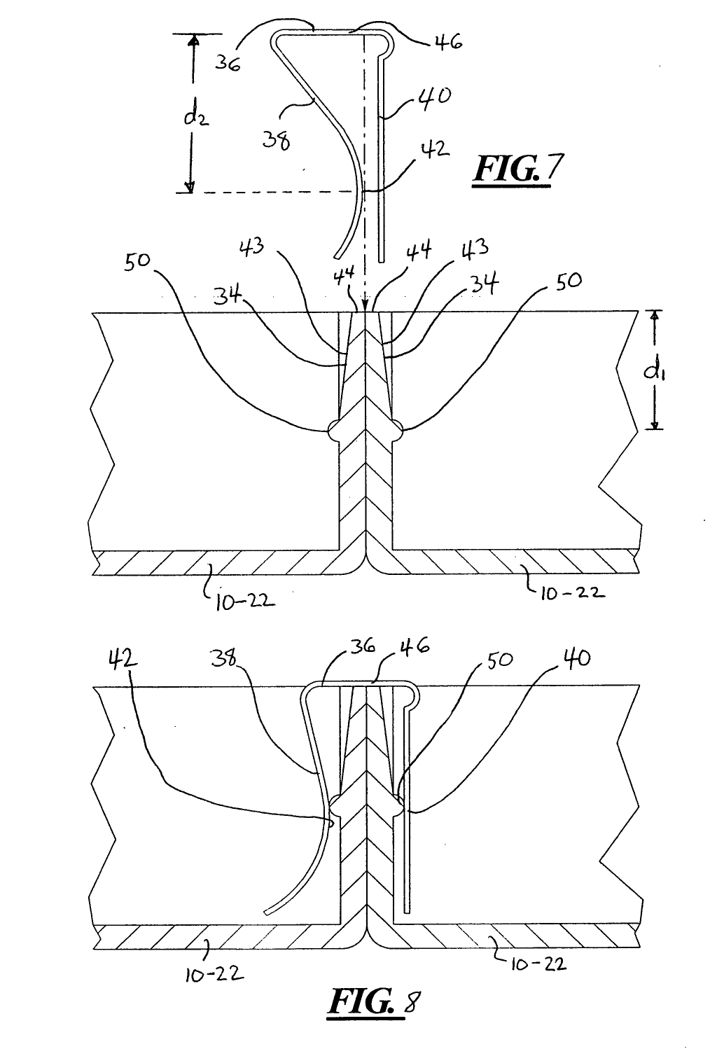

As shown in FIGS. 2 and 3, each of the components 10-22 is provided with a plurality of rearwardly-projecting walls 26, 28, 30, 32. Each rearwardly-projecting wall 26-32 may have a reduced wall thickness over a clip-receiving span 34 thereof to facilitate installation of a clip 36 to interconnect adjacent components 10-22. The clip 36 is provided with a first leg 38 and a second leg 40, as shown in FIGS. 4, 5. The first leg 38 has a convex profile from a direction of the second leg 40, and the second leg 40 is generally flat. The clip 36 has a resiliency such that when the first leg 38 and second leg 40 are forced away from one another, at least an apex 42 of the first leg 38 is biased back toward the second leg 40.

The clip-receiving span 34 may also be tapered on at least an inside surface 43 thereof, such that the thickness of the rearwardly-projecting wall 26-32 becomes progressively thinner toward a rear edge 44 of the rearwardly-projecting wall 26-32. An outside surface 45 of the clip-receiving span 34 is preferably flat and perpendicular to a front-facing display surface of the component 10-22, so that when the rearwardly-projecting walls 26-32 of two components 10-22 are aligned adjacent one another, the outside surfaces of the clip-receiving spans 34 of both rearwardly projecting walls 26-32 are touching, or at least are in very close proximity to one another.

The tapered profile of the rearwardly-projecting wall 26-32 in the clip-receiving span 34 facilitates installation of a clip 36 on a pair of rearwardly-projecting walls 26-32 of adjacent components 10-22 by providing ramps along which one or both of the first and second legs 38, 40 of the clip 36 ride. The relative locations of the first and second legs 38, 40 of the clip, and showing one of the components provided with a second clip having a retention bracket to facilitate mounting the components to a vertical surface;

FIG. 4 is a perspective view of a clip used to connect adjacent messaging, personal convenience, and organizational product components of the present disclosure;

FIG. 5 is a perspective view of the clip shown in FIG. 4;

FIG. 6 is a rear perspective view of a clip having a retention bracket to facilitate mounting components to a vertical surface;

FIG. 7 is a cross-sectional view of two adjacent components, broken away, immediately prior to insertion of a clip over a rearwardly-projecting sidewall of each of the adjacent components; and

FIG. 8 is a cross-sectional view of two adjacent components, broken away, after insertion of a clip over a rearwardly-projecting sidewall of each of the adjacent components.

### DETAILED DESCRIPTION OF THE PREFERRED EMBODIMENTS

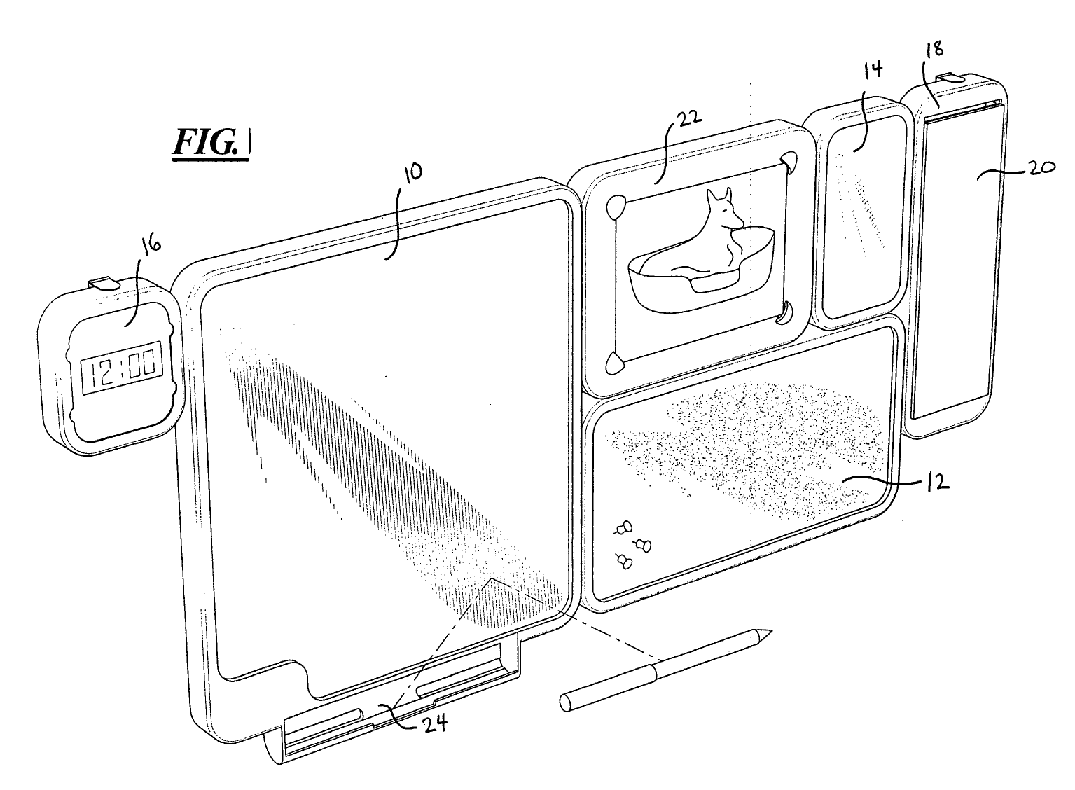

As illustrated in FIG. 1, a system of interconnected messaging, personal convenience, and organizational product components is provided. The system is modular and customizable, with all of the plurality of optional messaging, personal convenience, and organizational product components having compatible aesthetic and structural characteristics. The messaging, personal convenience, and organizational product components may include, by way of example, a dry-erase board 10, a wet-erase board (not shown), a pin-board 12 (such as corkboard, a fabric, or fabric-covered foam), a chalkboard (not shown), a mirror 14, a clock 16 (which may be digital, as illustrated, or analog), a support 18 for a pad of notepaper 20, a holder for a supply of gently adhesively interconnected self-sticking notes (not shown), a holder for a cellular telephone (not shown), a hook area for keys (not shown), a voice message recorder (not clip 36 are preferably such that the clip 36 may also be secured to a single rearwardly projecting wall 26-32, which is desirable for installing clips 36 to be used for hanging a single component 10-22, or an interconnected group of components 10-22, to a vertical surface. As pressure is applied to the clip 36 in a direction toward the front of a single component 10-22 (when the clip 36 is to be applied to a single rearwardly-projecting wall 26-32), or toward the front of adjacent components 10-22 (when the clip 36 is installed to secure the two adjacent components 10-22 to one another), for instance by a user pressing a thumb or forefinger on an intermediate portion 46 of the clip 36, the first and second legs 38, 40 are gradually urged apart from one another. As a result, at least the apex 42 of the first leg 38 is biased toward the second leg 40. Thus, when installed on a pair of rearwardly-projecting walls 26-32 of adjacent components 10-22, the resiliency of the clip 36 imparts a restoring force that presses the rearwardly-projecting walls 26-32 of the adjacent components 10-22 toward one another.

Other means of interconnecting adjacent components 10-22 are within the scope of the present disclosure. For instance, alternate fasteners may be used to interconnect the components, such as nuts and bolts, adhesive, or hook-and-loop fasteners.

The inside surface 43 of each rearwardly-projecting wall 26-32 is also preferably provided with an inwardly-directed ridge 50 in each clip-receiving span 34, spaced a distance d₁ from the rear edge 44 of the rearwardly-projecting wall 26-32 that is no more than a distance d₂ between the apex 42 and intermediate portion 46 of the clip 36. The inwardly-directed ridge 50 assists in securing the clip 36 to the rearwardly-projecting walls 26-32 of the adjacent components 10-22, and prevents inadvertent removal or twisting of the clip 36. Once the narrowest portion between the first leg 38 and second leg 40 of the clip 36 passes over the inwardly-directed ridges 50 of two adjacent rearwardly-projecting walls 26-32, the user may feel a tactile sensation, and/or hear an audible “snap”, as an indication that the clip 36 has been securely and correctly installed in order to verify the integrity of the connection between two adjacent components 10-22.

In a similar fashion, a rearwardly-projecting wall 26-32 of a third component 10-22 may be aligned adjacent any of the unoccupied rearwardly-projecting walls 26-32 of the first two components 10-22. A second clip 36 may then be applied to the clip-receiving spans 34 of the rearwardly-projecting wall 26-32 of the third component 10-22 and of the previously unoccupied rearwardly-projecting wall 26-32, thereby interconnecting three components 10-22. This process can be repeated until all desired components 10-22 are interconnected, with each component 10-22 arranged at a desired location. While each of the interconnected components 10-22 would typically be a different messaging, personal convenience, or organizational product than all of the other interconnected components 10-22, it is recognized that an individual may use more than one of the same messaging, personal convenience, or organizational product component 10-22. For instance, two or more clocks 16 may be provided in a single set of interconnected components 10-22, so that the individual could keep track of time in multiple time zones.

The clips 36 may be provided with an aperture 52, such as in one of the first and second legs 38, 40, to receive a retention bracket 54, including at least one fastener-receiving hole 56 through which a nail, tack, screw, or similar fastener, or a hook, may pass, to facilitate mounting one or more interconnected components 10-22 to a vertical surface, such as a wall.

While certain embodiments have been disclosed herein, this disclosure is not intended to be limited thereto. It is recognized that variations may be made to the disclosed embodiments that are still within the scope of the appended claims.

What is claimed is:

1. A system for interconnecting a plurality of complementary components comprising:
a plurality of components, each of said components having a front surface and a plurality of walls projecting rearwardly from the front surface, at least two of the components arranged adjacent one another with one of the rearwardly-projecting walls of each of the adjacent components aligned with one another; and
a fastener selectively securable to one or more of the rearwardly-projecting walls, said fastener being operable to interconnect a pair of the rearwardly-connecting walls.

2. The system of claim 1, wherein the fastener is a clip having first leg and a second leg and an intermediate portion between the first and second legs, one of the first and second legs being biased toward the other when either of the legs is urged in a direction away from the other; said clip being installed on the aligned rearwardly-projecting walls of the at least two components.

3. The system of claim 2, wherein at least one of the rearwardly-projecting walls of each of the components includes a clip-receiving span having a wall thickness adapted to facilitate installation of the clip thereon.

4. The system of claim 2, wherein in a clip-receiving span of at least one of the rearwardly-projecting walls of each of the components includes a wall thickness that tapers from a relatively thick portion to a relatively narrow portion at a rear edge of the rearwardly-projecting wall.

5. The system of claim 4, wherein an outer surface of the clip-receiving span is flat and perpendicular to the front surface.

6. The system of claim 4, wherein the clip-receiving span includes an inwardly directed ridge over which one of the first and second legs of the clip passes to enhance securement of the clip on the aligned rearwardly-projecting walls of the at least two components.

7. The system of claim 2, wherein at least one of the first and second legs of the clip is convex in shape from a direction of the other of the first and second legs.

8. The system of claim 2, wherein the clip is provided with an aperture in one of the first and second legs and a retention bracket is received in the aperture, the retention bracket including a fastener-receiving hole to facilitate mounting the plurality of interconnected components to a vertical surface.

9. The system of claim 1, wherein each of the plurality of components is selected from a group of: a dry-erase board, a pin-board, a chalkboard, a mirror, a clock, a support for a pad of notepaper, a holder for a supply of gently adhesively interconnected self-sticking notes, and a picture display panel.

10. A method of interconnecting a plurality of components comprising:
arranging a first component having a front surface and a plurality of walls projecting rearwardly from the front surface, adjacent a second component having a front surface and a plurality of walls projecting rearwardly from the front surface, such that one of the rearwardly-projecting walls of the first component is aligned adjacent one of the rearwardly-projecting walls of the second component; and
installing a fastener to at least one of the aligned and adjacent rearwardly-projecting side walls to secure the first and second components in their aligned and adjacent orientation relative to one another.

11. The method of claim 10, wherein in installing the fastener, said fastener is a clip having a first leg, a second leg, and an intermediate portion between the first and second leg over, and the clip is installed over the aligned and adjacent rearwardly-projecting sidewalls of the first and second components.

12. The method of claim 11, wherein in installing the clip, the first leg and the second leg are urged apart from one another by exerting pressure on the intermediate portion in a direction toward the front surface of the first and second components such that at least one of the first leg and the second leg rides along a ramped tapered clip-receiving span of one of the aligned and adjacent rearwardly-projecting sidewalls.

13. The method of claim 11, wherein in installing the clip, the first leg and the second leg are urged apart from one another by exerting pressure on the intermediate portion in a direction toward the front surface of the first and second components until an apex of at least one of the first and second legs passes over an inwardly-projecting ridge provided on a clip-receiving span of one of the aligned and adjacent rearwardly-projecting sidewalls.

14. The method of claim 10, and further arranging at least one additional component having a front surface and a plurality of walls projecting rearwardly from the front surface adjacent at least one of the first and second components, such that one of the rearwardly-projecting walls of the at least one additional component is aligned adjacent an unoccupied one of the rearwardly-projecting walls of at least one of the first and second components, and installing at least one additional clip having a first leg, a second leg, and an intermediate portion between the first and second leg, over the aligned and adjacent rearwardly-projecting sidewalls of the at least one additional component and of one of the first and second components.

15. The method of claim 10, and selecting each of the plurality of components from a group of: a dry-erase board, a pin-board, a chalkboard, a mirror, a clock, a support for a pad of notepaper, a holder for a supply of gently adhesively interconnected self-sticking notes, and a picture display panel.

16. The method of claim 11, and installing an additional clip having a first leg, a second leg, and an intermediate portion between the first and second leg, an aperture in one of the first and second legs, and a retention bracket received in the aperture, the retention bracket including a fastener-receiving hole, and mounting the plurality of interconnected components to a vertical surface by inserting a fastener through the fastener-receiving hole of the retention bracket and securing said fastener to the vertical surface.
